(19) United States
(12) Patent Application Publication
(10) Pub. No.: US 2007/0155422 A1
(43) Pub. Date: Jul. 5, 2007

(54) Method for controlling mobile data connection through USB Ethernet management of mobile station

(76) Inventors: Harald Johansen, Rykene (NO); Petter Johnsen, Arendal (NO)

Correspondence Address: POTOMAC PATENT GROUP, PLLC, P. O. BOX 270, FREDERICKSBURG, VA, 22404, US

(21) Appl. No.: 11/273,600

(22) Filed: Nov. 14, 2005

(51) Int. Cl. H04M 1/00

(52) U.S. Cl. 455/556.1

(57) ABSTRACT

A method and system of communication is disclosed. The method comprises the steps of: establishing an universal serial bus (USB) connection between a computing device and a mobile communication device; the mobile communication device identifying itself as an USB Ethernet adapter to the computing device; configuring an Ethernet interface between the computing device and the mobile communication device based on the identity provided by the mobile communication device; activating a mobile data connection between the mobile communication device and a network; and communicating data using internet protocol frames between the computing device and the network via said mobile computing device.

### BACKGROUND

This invention relates to communication systems and more particularly to providing access for a computing device to a network via a mobile communication device.

In order for a computing device, such as a personal computer (PC), to access a network, it is common to establish a communication link between the PC and the network via a mobile communication device or mobile station (MS) as illustrated in FIG. 1. The PC can be a portable computer (such as a laptop computer) for example. The mobile communication device/station can be a mobile phone and the network can be the internet.

As illustrated in FIG. 1, both PC 110 and mobile station (MS) 120 include USB (Universal Serial Bus) ports 112 and 122 respectively. A connection between PC 110 and MS 120 can be established by connecting a cable, such as USB cable 115, between ports 112 and 122.

In this type of connection, PC 110 controls MS 120. Mobile station 120 identifies itself as a modem (in USB terms, an Abstract Control Model or ACM modem) to PC 110. Mobile station 120 is seen as a modem by PC 110 as mobile station 120 emulates a modem.

To enable PC 110, to use MS 120 for connecting the PC to network 130, MS 120 operates in a way such that PC 110 behaves as if it were using a traditional circuit-switched (CS) modem (using a dial-up connection) via the USB port. Such USB modem emulation, entails control of MS 120 by the usual AT commands and in particular that a connection is set up by the AT Dial command. It will be understood that in general the AT prefix (also known as the Attention Code) signals the modem that one or more commands are to follow.

This type of connection, however, cannot be established easily. Information needed for configuring this set-up is neither commonly known nor is it intuitive. For example, normal phone numbers are not used. The user needs to create a new dial-up networking connection including selecting the correct emulated USB modem and setting the correct virtual telephone number. A virtual telephone number may be represented by an alpha-numeric string such as ATD*99***1#, etc.

Furthermore, modem communication over USB involves an emulated serial interface which is octet based. All the packets (that are being transmitted and received) need to be serialized; this process affects link and processor capacity.

### SUMMARY

Among other things, this invention solves the problem associated with using a mobile station emulating a dial-up modem for establishing a communication connection between a PC and a network.

In one embodiment, a mobile terminal capable of enabling a terminal equipment to communicate with a network, comprises: a first interface for establishing a connection to the terminal equipment; a second interface for establishing a connection to the network; and a processor configured to identify the mobile terminal to the terminal equipment as an USB Ethernet adapter upon the mobile terminal being connected to the terminal equipment.

In another embodiment, a method of communication comprises the steps of: connecting a computing device to a mobile communication device via USB; the mobile communication device identifying itself as an USB Ethernet adapter to the computing device; establishing a communication connection between the computing device and the mobile communication device based on the identity provided by the mobile communication device; activating a mobile data connection between the mobile communication device and a network; and communicating data using internet protocol (IP) frames between the computing device and the network via said mobile computing device.

In yet another embodiment, a computer-readable medium containing a computer program for communicating data between a computer and a network. The computer program causes: the computer to establish connection to a mobile communication device via USB; the mobile communication device to identify itself as an USB Ethernet adapter to the computing device; establishment of a communication connection between the computing device and the mobile communication device based on the identity provided by the mobile communication device; activation of a mobile data connection between the mobile communication device and the network; and communication of data using internet protocol (IP) frames between the computing device and the network via the mobile computing device.

### BRIEF DESCRIPTION OF THE DRAWINGS

The various features, advantages, and objects of this invention will be understood by reading this description in conjunction with the drawings, in which:

FIG. 1 illustrates a communication connection between a PC and a network via a mobile device emulating a dial-up modem;

FIG. 2 illustrates an exemplary communication connection between a computing device and a mobile station;

FIG. 3 is an exemplary flow diagram illustrating translating and bridging of control messages between a PC and a network via a mobile station (MS);

FIG. 4 illustrates an exemplary method for facilitating communication between a PC and a network via a MS; and

FIG. 5 illustrates a NDIS status at various stages of the method illustrated in FIG. 4.

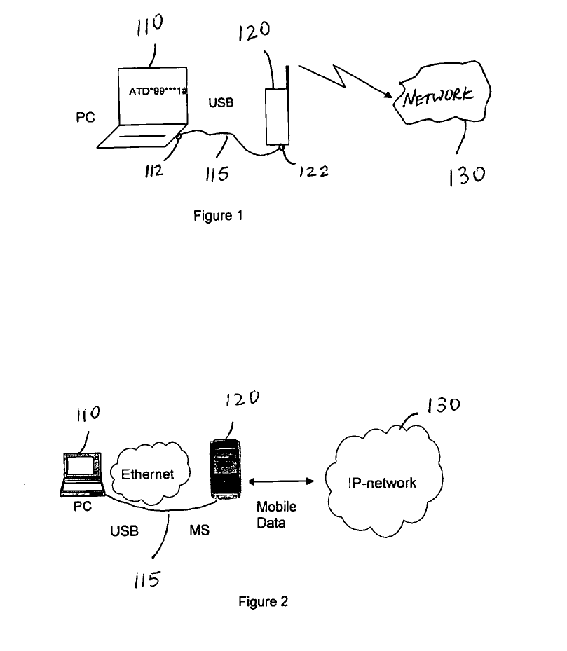

### DETAILED DESCRIPTION

The following description of the implementations consistent with the present invention refers to the accompanying drawings. The same reference numbers in different drawings identify the same or similar elements. The following detailed description does not limit the invention. Instead, the scope of the invention is defined by the appended claims.

In general, the present invention is a system and method for establishing communication between a computing device, such as a personal computer (PC), and a network. The PC may also be referred to as terminal equipment (TE). Specifically, a mobile station (such as a mobile phone) may facilitate PC access to the network via USB between the PC and the mobile station. The mobile station may also be referred to as a mobile terminal. The mobile station (MS) may emulate (or identify itself to the PC as) an USB Ethernet adapter and facilitate the establishment of a communication connection between the MS and the PC.

An exemplary embodiment may be described with reference to FIG. 2. A PC 110 may be connected to a MS 120 via USB 115. Upon establishing this connection, MS 120 may identify itself as one or more USB Ethernet adapters. The mobile station (the USB client in this case) may inform the PC (the USB master in this case) of the services it (i.e. MS 120) supports. More specifically, MS 120 may inform PC 110 that MS 120 supports Ethernet.

PC 110, therefore, may discover that there exists an Ethernet interface 118 on this device (MS 120). As a result, an USB Ethernet control protocol may be used to facilitate communication between PC 110 and MS 120. PC 110 may view MS 120 as an USB Ethernet adapter and control a mobile data connection (to network 130) via USB Ethernet control messages sent or communicated to MS 120.

A communication connection may be established between PC 110 and MS 120 based on the identity provided by the MS within present operating systems (such as Microsoft® Windows® or Windows XP® operating systems for example). Drivers for a plurality of USB Ethernet adapters may be included within PC 110. Upon MS 120 identifying itself as an USB Ethernet adapter to PC 110, an icon may appear on the task bar within a Windows Operating System (OS) user interface of the PC. This icon may indicate that new hardware has been found. An interactive or automatic setup wizard may then complete the task of establishing MS 120 as an USB Ethernet adapter by matching the information received from MS 120 with pre-stored driver information in PC 110. A driver for the USB Ethernet adapter may be identified for establishing the communication connection between PC 110 and MS 120.

In addition to conveying setup information to PC 110 (i.e. MS 120 identifying itself as an USB Ethernet adapter), MS 120 may also control shutdown and status of mobile data connections to PC 110 via the USB Ethernet protocol. The status of mobile data connections (i.e. whether connection between MS and network exists) may be provided by sending an Ethernet cable (i.e. a virtual Ethernet cable between PC 110 and MS 120) status from mobile station 120 to PC 110. PC 110 may initiate this query to MS 120. If the connection exists, the cable status may be designated as “inserted” and if the connection does not exist, the cable status may be designated as “unplugged”.

Since MS 120 is intermediate PC 110 and network 130, MS 120 may translate and bridge messages between PC 110 and network 130.

The format for messages between PC 110 and MS 120 is different from the format for messages between MS 120 and network 130. Therefore, MS 120 needs to translate between the message formats. MS 120 may include logic for translation of the messages from one format to another format. MS 120 may translate USB Ethernet control messages (between PC 110 and MS 120) and mobile data connection control messages (between MS 120 and network 130).

MS 120 may also bridge the messages. That is, MS 120 may include logic for knowing that when a message is received in one format, the received message has to be translated and transmitted.

That is, if a message is received by MS 120 (emulating an USB Ethernet adapter) from PC 110 (USB Ethernet control message), MS 120 may translate the received message into a format (data connection control message) suitable for transmission to network 130. Similarly, if a message is received by MS 120 from network 130 (data connection control message), MS 120 may translate the received message into a format (USB Ethernet control message) suitable for transmission to PC 110.

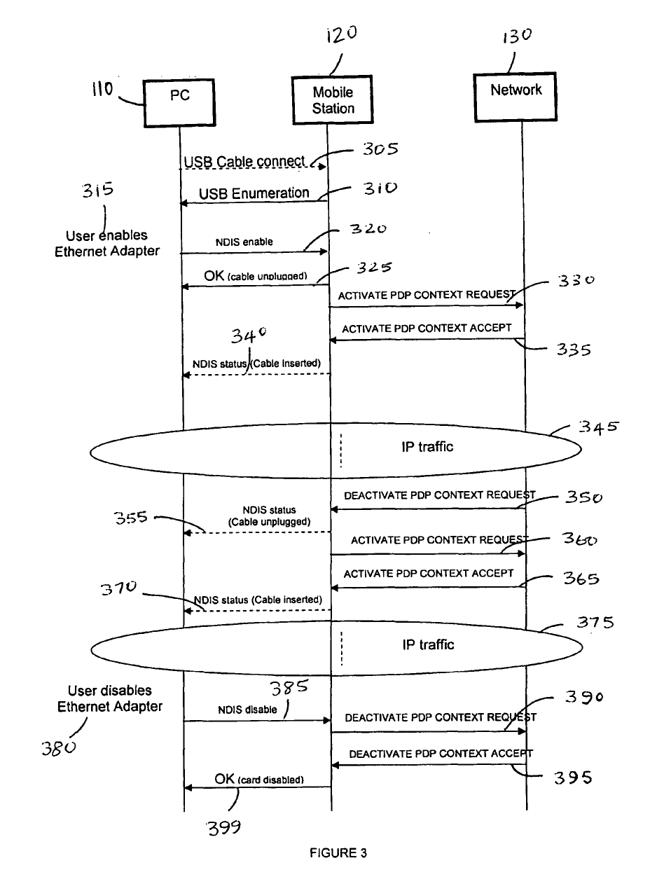

The translation and bridging of messages as described above may be viewed as two separate functions or, in the alternative, they may be viewed as a single function. 100291 An exemplary flow of translating and bridging of control messages when a mobile data connection is controlled from a PC is illustrated in FIG. 3.

Upon inserting (or connecting) a (physical) USB cable 115 between PC 110 and MS 120 at 305, USB enumeration may take place between MS 120 and PC 110 at 310 leading to MS 120 identifying itself as an USB Ethernet adapter to PC 110. The capabilities of the USB Ethernet adapter being emulated by MS 120 (or, the services supported by MS 120) may be communicated to PC 110. PC 110 may then load the appropriate drivers based on, for example, a user selection of the available (as indicated by MS 120) Ethernet adapters at 315. A network driver interface specification (NDIS) may then be enabled based on the identified driver from the pre-stored list of drivers on PC 110 resulting in recognition of MS 120 as an USB Ethernet adapter by PC 110.

A NDIS enable request at 320 from PC 110 to MS 120 (query from PC to MS described above) may return an “OK (cable unplugged)” response from MS 120 to PC 110 at 325. The “OK” may indicate that an emulated Ethernet adapter has been setup and enabled between MS 120 and PC 110.

The “cable unplugged” status corresponds to the state of the emulated Ethernet adapter with respect to the network connection between MS 120 and network 130. At this point, the network connection has not been established thus resulting in the “cable unplugged” status. As described below, if the network connection has been established between MS 120 and network 130, a “cable inserted” status may instead be communicated between MS 120 and PC 110.

An “activate PDP (packet data protocol) context request” may be issued from MS 120 to network 130 at 330 and an “activate PDP context accept” may be issued from network 130 to MS 120 at 335 to establish communication between MS 120 and network 130.

In order to establish communication between PC 110 and network 130, a NDIS status of “cable inserted” may be issued from MS 120 (now seen as an USB Ethernet adapter by PC 110) to PC 110 at 340. The PC is informed that Ethernet traffic may be facilitated on the emulated Ethernet adapter. This will also enable the PC to send IP (internet protocol) frames to network 130 via MS 120.

Communication between PC 110 and network 130 may now take place via MS 120 at 345 using an air interface within a cellular communication network for example.

A “deactivate PDP context request” may be issued at 350 by network 130 to MS 120 (e.g. if the mobile station strays outside a coverage area or loses connection with a base station). MS 120 may then issue a NDIS status of “cable unplugged” to PC 110 at 355 indicating (to PC 110) that communication over the emulated Ethernet 118 (that has been configured between PC 110 and MS 120) cannot take place as the network connection has been lost, etc. Ethernet 118 is still configured at this point (since the physical USB cable is still connected between PC 110 and MS 120) but no communication with the network is possible.

Since the Ethernet is still configured between PC 110 and MS 120 at this point (physical cable still plugged in and USB enumeration has taken place), MS 120 may automatically re-establish connection to network 130. An “activate PDP context request” may be issued from MS 120 to network 130 at 360 and an “activate PDP context accept” may be issued from network 130 to MS 120 at 365 to re-establish the communication between MS 120 and network 130 as described above.

If the communication is re-established, MS 120 may issue a NDIS status of “cable inserted” to PC 110 at 370 to indicate that communication over the Ethernet can be facilitated (IP traffic 375) as described above.

The emulated Ethernet may be disabled by a user of PC 110 at 380. An NDIS disable may be communicated to MS 120 by PC 110 at 385 indicating that the Ethernet adapter emulation has been terminated by the user.

A “deactivate PDP context request” may be issued by MS 120 to network 130 at 390 and a “deactivate PDP context accept” may be issued by MS 120 to network 130 at 395 to terminate the network connection. Upon the deactivation, MS 120 may return a “disabled” status to PC 110 indicating termination of the emulated Ethernet.

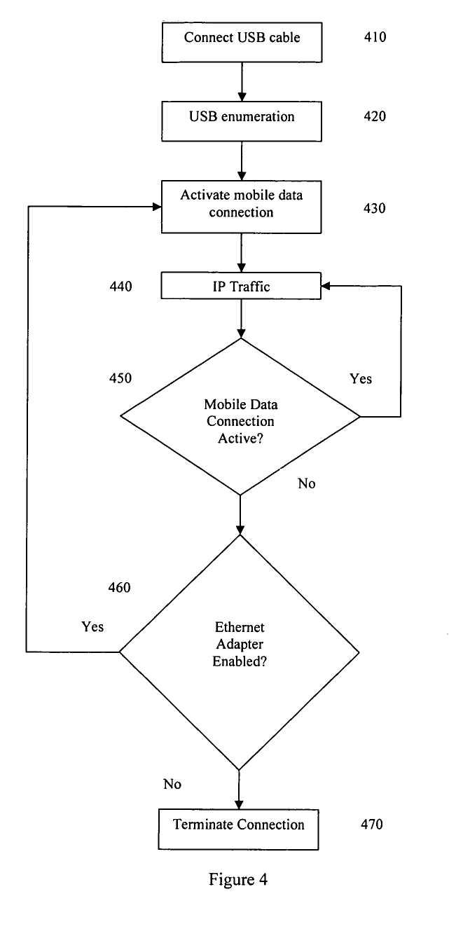

An exemplary method may be described with reference to FIG. 4. A USB cable may be inserted between a PC and MS at 410. USB enumeration may take place at 415 to establish a communication connection (i.e. a virtual Ethernet) between PC 110 and MS 120 as described above with reference to FIG. 3. A mobile data connection between MS 120 and network 130 may be established at 430. PC 110 may control MS 120 to transmit and receive IP traffic at 440.

This process (IP traffic) may continue while the mobile data connection is active as determined at 450. If the mobile data connection is not active at 450, a determination is made at 460 as to whether the Ethernet is configured between PC 110 and MS 120.

If the Ethernet is enabled (and mobile data connection is not active as determined at 450), mobile data connection may be activated at 430 (or, re-established in this case) since the Ethernet is still configured between PC 110 and MS 120).

If the Ethernet is disabled or removed, data connection between MS 120 and network 130 may be terminated at 470 (Deactivate PDP Context Request 390 and Deactivate PDP Context Accept 395 of FIG. 3).

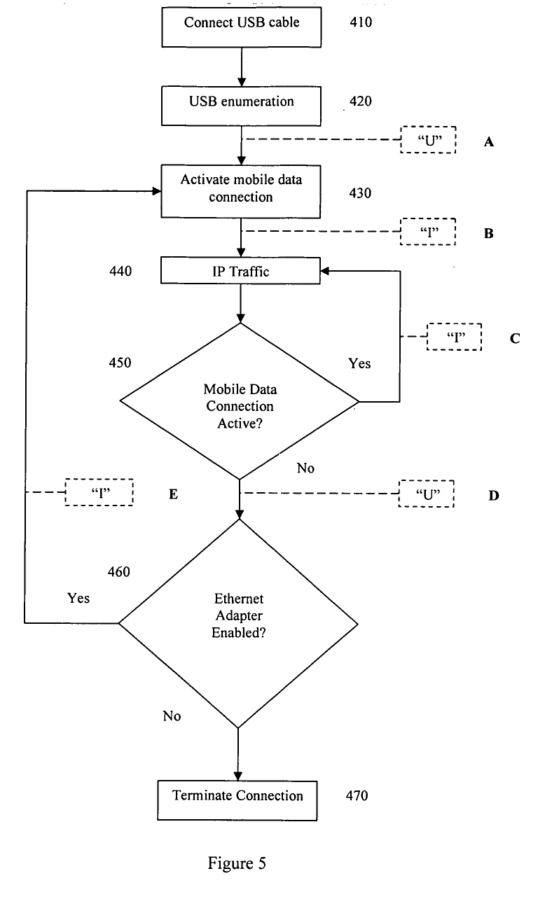

The NDIS status requests described with reference to FIG. 3 may also be illustrated in FIG. 5 in conjunction with the method described in FIG. 4. As illustrated (in FIG. 5), the NDIS status requests may result in a “I” or “U” corresponding to the (virtual) Ethernet or cable being inserted or unplugged at each of points A, B, C, D and E.

While the network has been referred to as the internet for example, the network may be thought of as a cellular IP based data network. The data network may be connected to the internet or to an intranet or to private network.

A processor within MS 120 may be configured to identify MS 120 as an USB Ethernet adapter to PC 110 upon PC 110 being connected to MS 120 via USB. A processor within MS 120 may also be configured to interact with PC 110 to establish the communication connection with PC 120 based on the identity provided by the mobile terminal (i.e. as USB Ethernet adapter) and input from PC 110 (user selection of a USB Ethernet adapter, etc.). A processor within MS 120 may additionally be configured to perform the translation and bridging of messages as described above. A processor may further be configured to activate connections with network 130. The functions described may be performed by separate processors or by a single processor.

In some embodiments, each data account within a MS may emulate an individual USB Ethernet adapter to the PC. Therefore, if a user has two accounts (one for accessing his or her company's intranet and one for accessing a public network such as the internet) for example, the user's MS may present itself as having two separate USB Ethernet adapters to the PC. The user may then be given a choice to enable one or both (or none) of the accounts.

While the embodiment described herein illustrates GSM/UMTS packet service (GPRS), the present invention may also be used to control a circuit switched GSM/UMTS connection.

The methods described herein are not limited exclusively to communication via USB between PC 110 and MS 120. The exemplary methods described herein may be equally applicable to any situation where it is possible to control external Ethernet adapters from a PC. Methods described herein may be adapted to any technology that may be substituted for Ethernet as LAN technology. These methods may also be used where a PC enables and disables an adapter and receives status of data connection (for example, as a “cable inserted” or a “cable unplugged”).

Exemplary methods as described facilitate setup and configuration of mobile data connections from a PC as an automated procedure (using an icon on screen followed by automatic configuration based on a minimum user input for example). Methods of the present invention may be based on a packet interface as opposed to being based on a serial interface. A packet interface adds less overhead to data being communicated. In comparison to a serial interface, a packet interface requires less CPU resources for a MS to send and receive packet data.

Moreover, this invention can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a random-access memory (RAM), a read-only memory (ROM), an erasable programmable read-only memory (EPROM or Flash memory), and an optical fiber.

It is expected that this invention can be implemented in a wide variety of environments, including for example mobile communication devices. It will also be appreciated that procedures described above are carried out repetitively as necessary. To facilitate understanding, aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

It is emphasized that the terms “comprises” and “comprising”, when used in this application, specify the presence of stated features, integers, steps, or components and do not preclude the presence or addition of one or more other features, integers, steps, components, or groups thereof.

Thus, this invention may be embodied in many different forms, not all of which are described above, and all such forms are contemplated to be within the scope of the invention. The particular embodiments described above are merely illustrative and should not be considered restrictive in any way. The scope of the invention is determined by the following claims, and all variations and equivalents that fall within the range of the claims are intended to be embraced therein.

What is claimed is:

1. A mobile terminal capable of enabling a terminal equipment to communicate with a network, comprising:
a first interface for establishing a connection to the terminal equipment;
a second interface for establishing a connection to the network; and
a processor configured to identify the mobile terminal to the terminal equipment as an USB Ethernet adapter upon the mobile terminal being connected to the terminal equipment.

2. The mobile terminal of claim 1, wherein the processor is further configured to interact with the terminal equipment to establish a communication connection with the terminal equipment based on the identity provided by the mobile terminal and input from the terminal equipment.

3. The mobile terminal of claim 2, wherein the processor is further configured to translate data received from the terminal equipment in a first format to data in a second format and to transmit the data in the second format to the network.

4. The mobile terminal of claim 2, wherein the processor is further configured to translate data received from the network in a second format to data in a first format and to transmit the data in the first format to the terminal equipment.

5. The mobile terminal of claim 1, further comprising a memory for storing data related to a plurality of USB Ethernet adapters.

6. The mobile terminal of claim 1, further comprising a memory for storing data related to a plurality of user accounts, each of said accounts for accessing a network.

7. A method of communication, comprising the steps of:
connecting a computing device to a mobile communication device via USB;
the mobile communication device identifying itself as an USB Ethernet adapter to the computing device;
establishing a communication connection between the computing device and the mobile communication device based on the identity provided by the mobile communication device;
activating a mobile data connection between the mobile communication device and a network; and
communicating data using internet protocol (IP) frames between the computing device and the network via said mobile computing device.

8. The method of claim 7, further comprising:
communicating, by the mobile communication device to the computing device, services supported by the mobile communication device.

9. The method of claim 8, wherein the services include support for Ethernet.

10. The method of claim 9, wherein communication between the computing device and the mobile communication device takes place over a virtual Ethernet.

11. The method of claim 7, further comprising:
the mobile communication device translating data received from the communication device in a first format to a second format for transmission to the network.

12. The method of claim 7, further comprising:
the mobile communication device translating data received from the network in a second format to a first format for transmission to the computing device.

13. The method of claim 7, further comprising:
the computing device submitting a status check to the mobile communication device for determining a status of the mobile data connection.

14. The method of claim 13, further comprising:
the mobile communication device returning a cable unplugged status if the mobile data communication is inactive.

15. The method of claim 13, further comprising:
the mobile communication device returning a cable inserted status if the mobile data communication is active.

16. The method of claim 7, further comprising:
the mobile communication device identifying itself as a plurality of USB Ethernet adapters.

17. The method of claim 16, wherein each of the plurality of USB Ethernet adapters correspond to a network access account for an user of the mobile communication device.

18. The method of claim 16, further comprising:
the computing device selecting at least one of said plurality of USB Ethernet adapters.

19. A computer-readable medium containing a computer program for communicating data between a computer and a network, the computer program causing:
the computer to establish connection to a mobile communication device via USB;
the mobile communication device to identify itself as an USB Ethernet adapter to the computing device;
establishment of a communication connection between the computing device and the mobile communication device based on the identity provided by the mobile communication device;
activation of a mobile data connection between the mobile communication device and the network; and
communication of data using internet protocol (IP) frames between the computing device and the network via the mobile computing device.

20. The computer-readable medium of claim 19, wherein the activation of the mobile data connection causes the mobile communication device to translate data received from the computing device in a first format to a second format for transmission to the network.

21. The computer-readable medium of claim 20, wherein the activation further causes the mobile communication device to translate data received from the network in a second format to a first format for transmission to the computing device

22. The computer-readable medium of claim 20, wherein a disabling of the connection over USB causes deactivation of the mobile data connection.
